(19) United States
(12) Patent Application Publication
(10) Pub. No.: US 2026/0251122 A1
(43) Pub. Date: Aug. 27, 2026

(54) EXHAUST AIR POWER PLANT

(71) Applicant: The Charles Machine Works, Inc., Perry, OK (US)

(72) Inventor: Michael L. Anderson, Temecula, CA (US)

(21) Appl. No.: 19/534,334

(22) Filed: Feb. 9, 2026

Related U.S. Application Data
(60) Provisional application No. 63/761,339, filed on Feb. 21, 2025.

(51) Int. Cl. F03D 9/25; E02F 3/92

(52) U.S. Cl. CPC F03D 9/25; E02F 3/9243; F05B 2220/706

(57) ABSTRACT

A power generation system for vacuum-based equipment converts exhaust airflow into electrical energy. The system includes a blower creating vacuum pressure within a debris tank, an outlet duct directing exhaust air, and a turbine assembly positioned in the exhaust stream. The turbine may utilize a rotatable shaft with blades and at least one generator coupled to the shaft to produce electricity. Generated power may charge battery banks, supply the blower, or return energy to an electrical grid. The system extends operational runtime and reduces external charging needs.

### BRIEF DESCRIPTION OF THE DRAWINGS

FIG. 1 is a schematic and diagrammatic representation of a power generation system for a vacuum system, including a turbine which is adapted to charge one or more battery banks.

FIG. 2 is a schematic and diagrammatic representation of the power generation system of FIG. 1, with an inverter enabling power from the system to be returned to the grid.

FIG. 3A is a front perspective view of a turbine connected to a pair of generators.

FIG. 3B is an end view of the turbine.

FIG. 4 is a cutaway side view of a turbine within a silencer body.

### DETAILED DESCRIPTION

Vacuum excavation systems are used in various commercial applications, such as hydro and/or air excavation, to remove debris and other excavation material. Traditionally, these systems have used internal combustion engines to power vacuum system components, charge batteries, and run the vacuum systems. To date, no one in the vacuum excavation industry or other vacuum industries has developed systems that rely on or provide electrical generation and battery power.

Irrespective, batteries have limited life, and will not provide the runtime desirable for many industrial applications, such as vacuum excavation/operations. Systems are needed that may help provide charging capacity, extending battery life and/or runtime in the field before recharging becomes necessary.

The appended drawings depict a power generation system using exhaust airflow produced by the vacuum operation to drive a turbine that is external or internal to the vacuum unit itself. The power generation system may include an inlet duct pulling in atmospheric air and an outlet duct exhausting excess airflow to atmospheric air.

The power generation system may include a blower that is plumbed to the inlet duct and the outlet duct and configured to generate vacuum pressure within a vacuum tank of a vacuum system by pulling air in through the inlet duct and blowing air out through the outlet duct. The power generation system may include an exhaust turbine assembly within an exhaust airflow of the outlet duct.

The exhaust turbine assembly may include a rotatable turbine shaft and a plurality of turbine blades extending radially from the turbine shaft, the turbine blades configured to rotate the turbine shaft capturing the exhaust airflow. The power generation system may include at least one generator connected to the turbine shaft and may use planetary drives on one or both ends of the turbine shaft connected to the electrical generator(s). The generator(s) may be configured to convert rotation of the turbine shaft into electricity. The turbines can be oriented in a horizontal or vertical axis, or in other orientations other than horizontal or vertical, if appropriate for the discharge of exhaust airflow in a particular application.

The vacuum excavation system may include a trailer and a vacuum tank assembly. The vacuum system may include a vacuum tank assembly mounted on a skid. It should be understood that the vacuum tank assembly, and other similar machines, may be included on dedicated vehicles, including but not limited to a vacuum trailer, skid, or truck. The blowers in these vacuum systems may be positive displacement blowers, fan blowers, or centrifugal pumps or other mechanisms for air displacement or movement.

The vacuum tank assembly is designed to receive debris from a multitude of sources, e.g., air excavation, hydro excavation, slot trenching, etc. It is in communication with a blower plumbed in line to the vacuum tank via a vacuum conduit. The vacuum excavation system may include an inlet duct and an outlet duct, each positioned where the blower is built to generate vacuum pressure within the vacuum tank by pulling air in through the inlet duct and blowing air out through the outlet duct. Examples of vacuum excavation systems are found in U.S. Pat. No. 10,221,602, issued to Sewell, and U.S. Pat. No. 11,059,682, issued to Sewell, the contents of which are incorporated by reference herein.

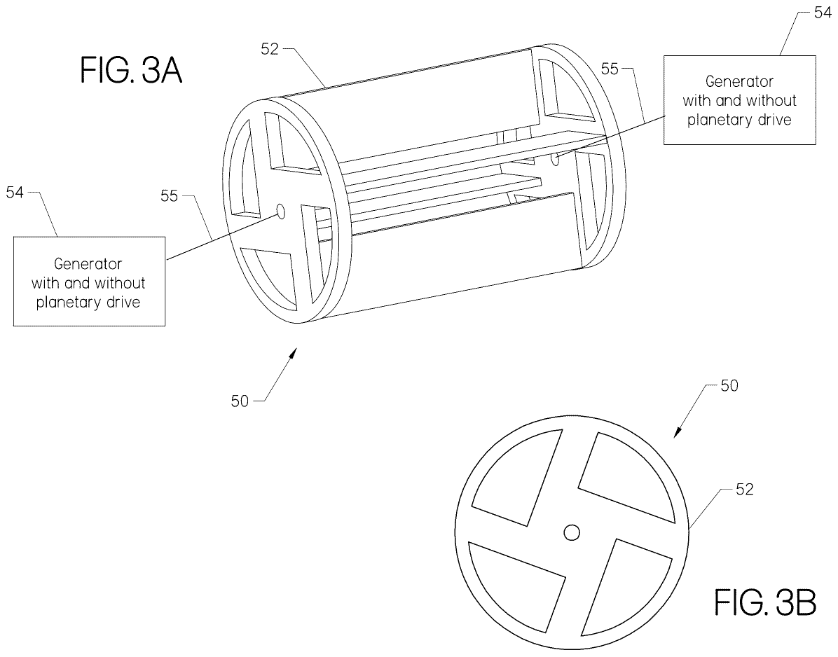

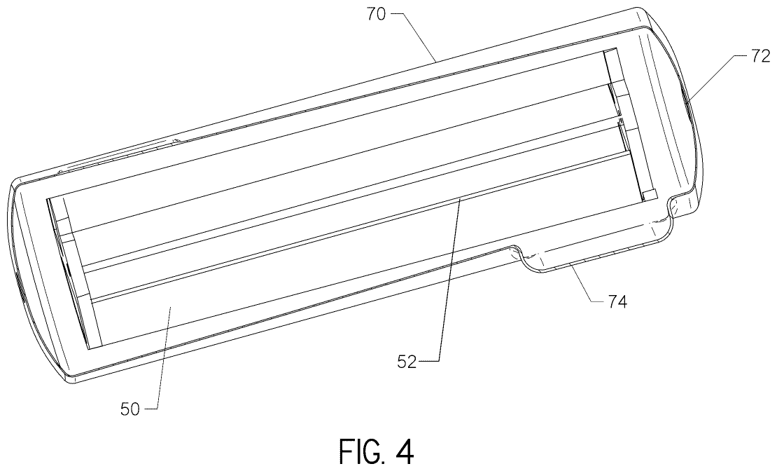

The power generation system may include an exhaust turbine assembly within an exhaust airflow of the outlet duct, as shown in FIGS. 3A-4. Such an exhaust turbine assembly may include a rotatable turbine shaft and a plurality of turbine blades extending radially from the turbine shaft. The turbine blades may be configured to rotate the turbine shaft in response to the exhaust airflow. The system may include at least one generator connected to the turbine shaft, the at least one generator configured to convert rotation of the turbine shaft into electricity. The system may include one or two generators affixed to the turbine in any configuration and may also include planetary gearboxes in between the turbine and the generator(s), connected via the main shaft off the turbine.

The drawings disclose a power generation system that may be used with exhaust systems of various types of machines and/or vehicles. For example, the power generation system may be used with vacuum air excavators, hydro excavators, septic tank trucks, industrial vacuum trucks, etc., but not limited to only these applications.

In general, the power generation system may capture flow of exhaust airflow, or intake airflow, from or to a vacuum blower or other exhaust/intake source to spin a turbine. The turbine may be mounted vertically or horizontally, have fin style blades, be mounted externally to reduce/avoid parasitic loss, or be mounted internally, such as in components like silencers (e.g., by replacing the silencer baffles). The turbine may then spin electric generators to generate power that may be used for any of a variety of applications, such as charging on-board batteries. When a machine is powered by batteries or a hybrid engine/battery system, the power generation system may help extend run time and/or reduce need for the machine to return to a charging facility.

The power generation system may be used with vacuum excavation systems or other machinery powered by virtually any power source as a primary driver/source of airflow. For example, the power generation system may be a gasoline, diesel, or hybrid engine, electric blower, battery, etc. The power generation system may be driven by both intake/exhaust and/or ambient natural wind sources. While usable for vacuum excavation applications, either with trucks or trailers, the power generation system may be used in virtually any undercarriage.

In some versions, the power generation system may include an electric vehicle-to-grid option. In some versions, the power generation system may additionally include solar panels mounted on the vacuum system or elsewhere on the machine or vehicle that may provide additional power generation for the vacuum system. In some versions, the solar panels may be spray or flex solar panels that may be placed on the undercarriage, trailer, truck, or other suitable machinery.

The exhaust airflow from many commercial vacuum systems could provide adequate, or more than adequate, enough airflow in cubic feet per minute (CFM), to spin a turbine and at least one generator in order to create a significant electrical charge for a system's batteries. Existing vacuum systems generate airflow, at minimum, 200 CFM and may generate 5,500 CFM for the larger units and even more on fan driven units.

Vacuum systems, implementing the power generation system described herein, may supply enough air stream speed to spin a turbine that may be matched in size to the output, which will generate electricity and charge varying levels of a battery bank(s). Air speeds from the exhaust of a typical vacuum excavation system may range from 30-80 miles per hour (MPH).

The power generation system may include a conventional wind turbine shape (e.g., windmill-style turbine), which may have a horizontal turbine axis and may include a tri-blade design, or any suitable blade amount. The power generation system may include a vertical axis turbine, or a horizontal axis turbine. The turbines of the power generation system may include variable pitch blades that may be adjusted manually or automatically depending on conditions, such as air stream volume, speed, etc. The turbines may include removable blades that may help to accommodate and customize the turbine to varying CFM/MPH of flow. An artisan will appreciate that the design of the turbine's blades may be chosen due to space constraints, and should be selected to maximize the conversion of kinetic energy within the exhaust air stream to charge generation and, thus, store power.

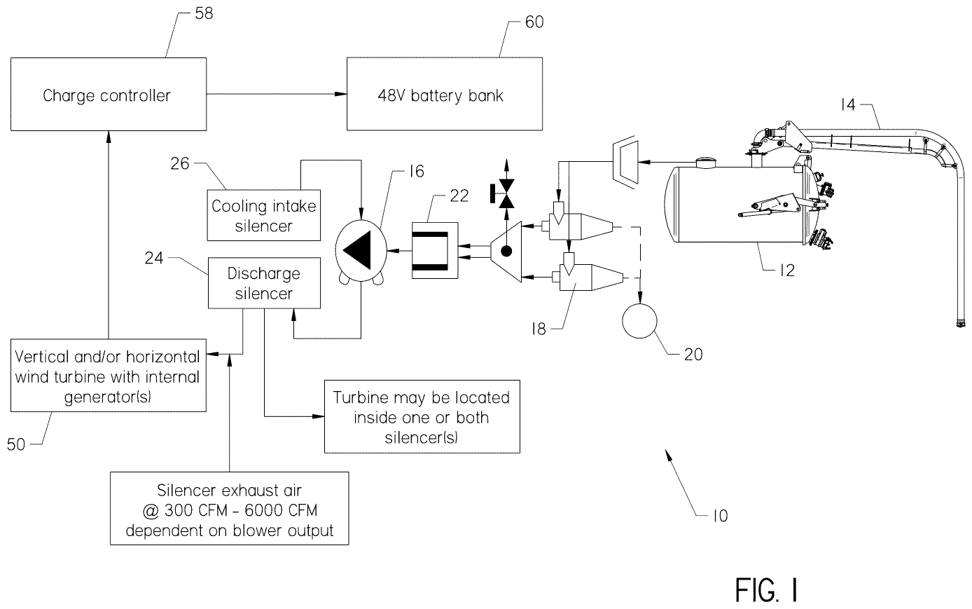

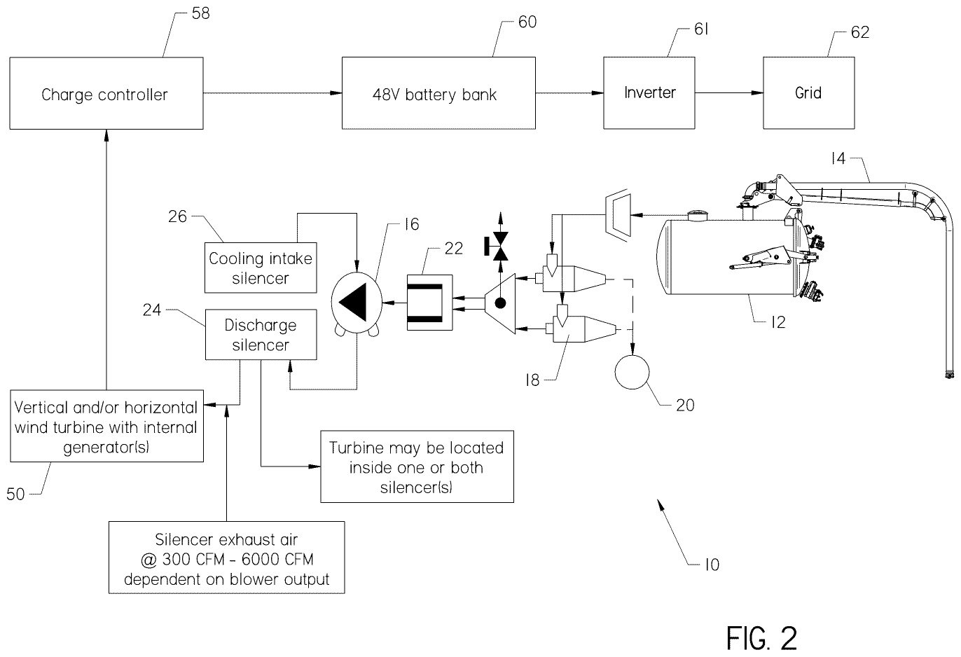

Turning now to the figures, FIGS. 1, 2 show variations of a flowchart for a power generation system 10 for a debris tank 12. The debris tank 12, such as that shown in the figures, is used to pull debris from an excavation operation through a boom 14. The boom 14 may also be considered the air inlet, as air is pulled through the debris tank 12, carrying the debris from an excavation site into the tank 12. A tank 12 may be used in many excavation contexts, for example, in microtrenching. In microtrenching, debris is often dry particulate dust, which can be carried in an air stream away from the site of an excavation into the debris tank 12.

The same forces that allow debris to be pulled into the tank 12 may also cause debris and dust to remain in an air stream. As shown in the figures, air is pulled out of the tank 12 by a blower 16 to maintain the flow into the tank 12 from the boom 14. To avoid the exhaust air containing particulate matter, which might cause environmental dust and damage to the blower 16 pulling the air through the power generation system, cyclonic separators 18 are provided. Solid particulate remaining in the stream falls into a particulate trap 20.

Any remaining dust in the stream may be removed by a filter 22. Preferably, most of the particulate is caught by the tank 12, with the majority of remaining particulate falling into the trap 20, so that the filter 22 may allow for high airflow without being clogged, and without the need for frequent replacement of filters. Alternatively, designs may be used which include cyclonic separators to avoid the use of paper filters.

In typical power generation systems, a discharge silencer 24 may be used at the exhaust to remove blower 16 noise from the environment as exhaust air is discharged from the system. In addition, a cooling intake silencer 26 may be used for any auxiliary cooling air that is taken into the blower 16. Often, a silencer 24 serves to dampen turbulent airflow that may occur within the system. Laminar airflow serves both to reduce noise and to increase a predictable, uniform, and powerful airflow through an exhaust. As shown in the schematics of FIGS. 1, 2, air from the discharge silencer 24 is provided to an exhaust, where a turbine 50 is situated.

In the present invention, a vertical or horizontal wind turbine 50 having fin style blades 52 may be placed within the silencer 24, or just outside of the silencer 24, in the exhaust stream. The turbine 50 may additionally be used as the silencer 24, using the blades 52 as noise dampeners and for power generation. Acoustic-attenuation structures within the silencer 24 cooperate with the blades 52 of the turbine to reduce noise.

The turbine 50, as discussed at length above, may have at least one generator 54 with single or dual planetary drive options to drive a motor for power generation. In some embodiments, the rotation of the turbine shaft 55 may, as a result of the intake or exhaust airflow, provide the mechanical energy for conversion into electrical energy, such as through electromagnetic induction. The electricity generated by the turbine 50 and/or motors may be provided to a charge controller 58 for recharging battery banks, supplying the grid 62, or for immediate use by the vacuum system. In some embodiments, the power generation system 10 may include concepts for a single generator, dual generators, or other combinations of generators.

The turbine may be a triblade design or a “Hamster Wheel” design as shown in FIG. 3A-3B. The blades 52 of the turbine 50 may have a variable pitch, and may be removable to accommodate varying levels of airflow. Additionally, the blades 52 may vary pitch manually or automatically depending on conditions, such as air stream volume, speed, etc. Further, the blades 52 may be removable to accommodate varying CFM of flow.

An artisan may appreciate that the best efficiency of such a turbine may be achieved using a forced-air ram style exhaust, as shown in FIG. 4.

In FIG. 4, the turbine 50 is disposed within a silencer housing 70. As shown in FIG. 4, the blades 52 are horizontally oriented and disposed about a central shaft 55. The shaft 55 should be understood to extend beyond the housing 70 such that it connects to the associated generator(s) 54 (FIG. 3). Thus, as air is received from the blower 16 (FIGS. 1, 2) at an inlet duct 74, the blades 52 and the shaft 55 rotate, causing the generator(s) 54 (FIG. 3) to charge the power generation system. Air exits at an outlet duct (not shown). The system of FIG. 4 may be in-line with a silencer 24 that reduces noise and encourages laminar airflow, or may be used in place of such a silencer.

While FIGS. 3-4 show the turbine 50 oriented horizontally, vertical orientations and other blade arrangements may be used without departing from the spirit of the invention.

The turbine 50 and/or the motors may be used to generate a charge, which may be used to charge one or more battery banks 60, such as in FIGS. 1, 2, and/or may be converted to alternating current by an inverter 61 and used to return electricity to an electric grid 62. Such turbines 50 can be combined with spray or flex solar panels to add to the charge generated. Turbines 50 may include an internal generator, such that when the turbine rotates with respect to its housing, electricity may be generated.

Ideally, in the situation shown in FIG. 2, the grid 62 may be used to both draw power, when needed, for charging the battery banks 60, and return excess power, if available, to the grid 62.

The tank 12 and the blower 16 may be powered by any potential power source, such as a gasoline, diesel, or hybrid engine. Electric power generated from this system may be used to supplement power to the blower 16.

Twin battery banks 60 are preferably utilized. A first bank may be used to run operation, with the other being charged by both the turbine 50 and, if applicable, by the grid 62. The banks 60 may be switched once the charging battery is full, or when the operating battery falls to a predetermined charge level. Additionally, connection to the grid 62 enables generated power to be utilized for return to the grid 62 when all applicable battery banks 60 are fully charged.

While this disclosure is focused on vacuum excavation, either on truck or trailer mounted vacuums, other exhaust systems with high airflow may be modified with the turbine 50 disclosed to generate charge.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A power generation system comprising:
an inlet duct in fluid communication with atmospheric air;
an outlet duct in fluid communication with atmospheric air;
a blower in fluid communication with the inlet duct and the outlet duct, the blower configured to generate vacuum pressure within a vacuum tank of a vacuum system by pulling air in through the inlet duct and blowing air out through the outlet duct; and
an exhaust turbine assembly disposed within an exhaust airflow of the outlet duct, the exhaust turbine assembly comprising:
a rotatable turbine shaft;
a plurality of turbine blades extending radially from the turbine shaft, the plurality of turbine blades configured to rotate the turbine shaft in response to the exhaust airflow; and
at least one generator connected to the turbine shaft, the at least one generator configured to convert rotation of the turbine shaft into electricity.

2. The power generation system of claim 1, further comprising one or more battery banks in electronic communication with the at least one generator and configured to be charged by the electricity generated by the at least one generator.

3. The power generation system of claim 2, wherein the one or more battery banks are in electronic communication with the blower and configured to supply the blower with electric power.

4. The power generation system of claim 2, further comprising a charge controller in electronic communication with the at least one generator and the one or more battery banks.

5. The power generation system of claim 1, further comprising an intake turbine disposed within an intake airflow of the inlet duct.

6. The power generation system of claim 5, wherein the at least one generator is connected to a turbine shaft of the intake turbine and configured to convert rotation of the turbine shaft into electricity.

7. The power generation system of claim 1, further comprising at least one silencer disposed on the outlet duct and in fluid communication with the blower, wherein the exhaust turbine assembly is disposed within the at least one silencer.

8. A vacuum excavation system comprising:
a vacuum tank configured to receive excavation debris;
a blower in fluid communication with the vacuum tank via a vacuum conduit;
an inlet duct and an outlet duct, each duct in fluid communication with the blower such that the blower is configured to generate vacuum pressure within the vacuum tank by pulling air in through the inlet duct and blowing air out through the outlet duct; and
an exhaust turbine assembly disposed within an exhaust airflow of the outlet duct, the exhaust turbine assembly comprising:
a rotatable turbine shaft;
a plurality of turbine blades extending radially from the turbine shaft, the plurality of turbine blades configured to rotate the turbine shaft in response to the exhaust airflow; and
at least one generator connected to the turbine shaft, the at least one generator configured to convert rotation of the turbine shaft into electricity.

9. The vacuum excavation system of claim 8, further comprising one or more battery banks in electronic communication with the at least one generator and configured to be charged by the electricity generated by the at least one generator.

10. The vacuum excavation system of claim 9, wherein the one or more battery banks are in electronic communication with the blower and configured to supply the blower with electric power.

11. The vacuum excavation system of claim 9, further comprising a charge controller in electronic communication with the at least one generator and the one or more battery banks.

12. The vacuum excavation system of claim 9, further comprising an intake turbine disposed within an intake airflow of the inlet duct.

13. The vacuum excavation system of claim 12, wherein the at least one generator is connected to a turbine shaft of the intake turbine and configured to convert rotation of the turbine shaft of the intake turbine into electricity.

14. The power generation system of claim 9, further comprising at least one silencer disposed on the outlet duct and in fluid communication with the blower, wherein the exhaust turbine assembly is disposed within the at least one silencer.

15. A power generation assembly for a vacuum system, comprising:
a silencer housing configured to receive an exhaust airflow generated by a blower of the vacuum system;
a rotatable turbine shaft extending through the silencer housing;
a plurality of turbine blades disposed within the silencer housing and extending radially from the turbine shaft, the plurality of turbine blades configured to rotate the turbine shaft in response to the exhaust airflow through the silencer housing; and
at least one generator operatively coupled to the turbine shaft and configured to convert rotation of the turbine shaft into electricity.

16. The power generation assembly of claim 15, further comprising acoustic-attenuation structures disposed within the silencer housing and cooperating with the plurality of turbine blades to reduce noise generated by the blower.
